(19) United States
(12) Patent Application Publication
(10) Pub. No.: US 2026/0238371 A1
(43) Pub. Date: Aug. 13, 2026

(54) PHOTONIC INTEGRATED WAVELENGTH-SELECTIVE SWITCH

(71) Applicant: SRI International, Menlo Park, CA (US)

(72) Inventor: Navin Bhartoor Lingaraju, Alexandria, VA (US)

(21) Appl. No.: 19/469,805

(22) PCT Filed: May 10, 2024
(86) PCT No.: PCT/US24/28917

§ 371 Date: Sep. 26, 2025

Related U.S. Application Data
(60) Provisional application No. 63/465,750, filed on May 11, 2023.

(51) Int. Cl. H04J 14/02

(52) U.S. Cl. CPC H04J 14/0212

(57) ABSTRACT

An example photonic integrated circuit includes a wavelength selective switch (WSS), the WSS including an input port configured to receive a plurality of optical signals. Each optical signal has a center wavelength and a signal bandwidth, and the center wavelength of each optical signal is different from the center wavelengths of the other optical signals. The WSS also includes an output port and a spectral filter configured to switch an optical signal of the plurality of optical signals to the output port based on the center wavelength of the optical signal.

### RELATED APPLICATIONS

This application claims priority from U.S. Provisional Application No. 63/465,750, filed 11 May 2023, the entire content of which is incorporated herein by reference.

### GOVERNMENT RIGHTS

This invention was made with Government support under contract No. DE-SC0021517 awarded by the Department of Energy. The Government has certain rights in this invention.

### TECHNICAL FIELD

This disclosure relates to optical transport networks and relates more particularly to wavelength selective switches for use within optical transport networks.

### BACKGROUND

Optical Transport Networks are high-speed networks designed to support the transportation of information over long distances sometimes by using optical signals and transmitting the information on multiple wavelengths simultaneously. Optical transport networks may also facilitate the transport of quantum information and be useful in various quantum applications.

Optical signals within an optical transport network must be switched between a series of nodes to enable the transport of information between two specific endpoints. Wavelength selective switches are devices that may allow network operators to selectively switch wavelengths to desired output ports/routes. Wavelength selective switches may be implemented using diffractive optical elements and spatial light modulators.

### SUMMARY

In general, the disclosure describes techniques and devices for wavelength selective switching. Example devices include photonic integrated circuits (PICs) including a wavelength selective switch (WSS), the WSS including cascaded spectral filters for switching the optical signals. The spectral filters may be configured to adjust a bandwidth of a selected optical signal, e.g., to adjust the signal bandwidth of the optical signal. Each set of cascaded spectral filers may include high, medium, and narrow bandwidth spectral filters, preferably realized using optical microresonators. The spectral filters may have adjustable bandwidths that can be tuned via resistive heating, enabling the WSS to adjust the bandwidth of the desired optical signal to be switched.

The techniques of this disclosure include one or more specific technical improvements that provide at least one practical application. The techniques and devices disclosed herein include a photonic integrated circuit including a WSS, which can be significantly more compact then a conventional WSS, and which provides adjustable bandwidths of optical signals as well as switching and routing of optical signals. The techniques and devices also provide polarization diversity allowing the WSS to utilize different polarization states rather than being dependent on an optical signal having a particular polarization state, which may allow for multiplexing/demultiplexing of a broad range of optical signals in a variety of photonic encodings. The techniques may also support finer resolution, introduce less optical loss, and reducing injection of unwanted light into the communication channel.

In one example, this disclosure describes a photonic integrated circuit including a wavelength selective switch (WSS), the WSS including: an input port configured to receive a plurality of optical signals, each optical signal having a center wavelength and a signal bandwidth, wherein the center wavelength of each optical signal is different from the center wavelengths of the other optical signals; an output port; and a spectral filter configured to switch an optical signal of the plurality of optical signals to the output port based on the center wavelength of the optical signal.

In another example, this disclosure describes a method including: receiving, by an input port of a wavelength selective switch (WSS) of a photonic integrated circuit, a plurality of optical signals, each optical signal having a center wavelength and a signal bandwidth, wherein the center wavelength of each optical signal is different from the center wavelengths of the other optical signals; and switching, by a spectral filter, an optical signal of the plurality of optical signals to an output port of the WSS based on the center wavelength of the optical signal, wherein the WSS comprises the spectral filter.

In another example, this disclosure describes a system including: a photonic integrated circuit comprising a wavelength selective switch (WSS); and processing circuitry configured to: configure a spectral filter of the WSS with a filter bandwidth.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a conceptual diagram illustrating an example network that includes a WSS implemented in a PIC, in accordance with one or more techniques of this disclosure.

FIG. 2 is a conceptual diagram illustrating an example cascaded filter system, in accordance with one or more techniques of this disclosure.

FIG. 3A is a conceptual diagram illustrating an example network that includes a WSS implemented in a PIC, in accordance with one or more techniques of this disclosure.

FIG. 3B is a conceptual diagram of an example layout of a WSS of FIG. 3A.

FIG. 4 is a flowchart of an example method of switching an optical signal by a WSS of a PIC, in accordance with one or more techniques of this disclosure.

Like reference characters refer to like elements throughout the figures and description.

### DETAILED DESCRIPTION

Quantum states of light may have linewidths on the order of 10s of MHz, as in the case of quantum emitters, or bandwidths in the 100s of GHz, as can be the case for time bin or polarization encoded photonic qubits. Quantum-compatible network hardware may be required to support all multiple photonic degrees of freedom. Adjustable filter bandwidths can allow for access to the broad range of bandwidths needed in quantum-compatible network hardware. Wavelength selective switches (WSS) and Fourier transform pulse shapers may be implemented using diffractive optical elements and spatial light modulators to map different optical signals to different points in space where the optical signals may then be routed to desired output ports/routes. WSS and Fourier transform pulse shapers may have large footprints, limited resolution, introduce high loss (limited transmission), and may inject unwanted light into output communication channels.

In accordance with the devices and techniques described herein, a WSS including cascaded spectral filters for switching optical signals may be implemented in a photonic integrated circuit (PIC). The WSS may enable a polarization diversity scheme to support optical signals with any arbitrary polarization and not modify the signal in a way that degrades the information. Additionally, integrating the WSS in a PIC leverages semiconductor infrastructure to support volume manufacturing of optical systems.

A photonic integrated circuit (PIC) is the optical equivalent of an electronic integrated circuit (IC) that manages the flow of light rather than the flow of electrons. Instead of diffractive optical elements and spatial light modulators, the PICs described in this disclosure may rely on micron-scale interferometers and microresonator-based filters to isolate and route wavelengths.

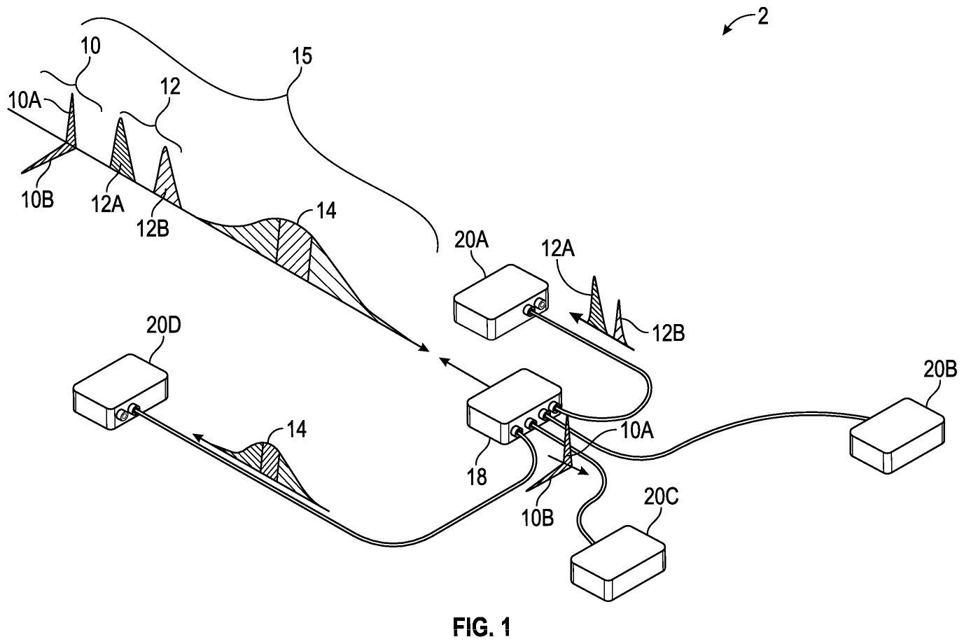

FIG. 1 is a conceptual diagram illustrating an example network 2 that includes WSS 18 implemented in a PIC, in accordance with one or more techniques of this disclosure. In the example shown, WSS 18 is configured to route data streams of multiplexed data stream 15 to one or more outputs, e.g., to endpoints 20A, 20B, 20C, and 20D (collectively referred to as, “endpoints 20”). Each of endpoints 20 may be associated with a different user, system, device, etc. Although network 2 illustrates WSS 18 with one input and four outputs, WSS 18 may include a different number of inputs and outputs, e.g., two or more inputs, or one, two, three, or five or more outputs.

Wavelength multiplexed data stream 15 may include a plurality of optical signals each assigned a wavelength and transmitted concurrently. In the example shown, the locations of each optical signal along wavelength multiplexed data stream 15 are separated for illustrative purposes to show an example of the spectral content of the optical signals, however, the optical signals of wavelength multiplexed data stream 15 may by spatially overlapping. Each optical signal of the plurality of optical signals included in wavelength multiplexed data stream 15 may have a center wavelength that may be different than the center wavelengths of the plurality of other optical signals, a signal bandwidth, and each optical signal may be encoded via a photonic encoding technique, e.g., polarization, time bin, frequency bin, or the like. For example, the optical signals of wavelength multiplexed data stream 15 may have a spectral shape, e.g., a boxcar shape, a gaussian shape, or any suitable spectral shape, having a spectral width, e.g., a bandwidth, and a characteristic wavelength, e.g., the center wavelength. The center wavelength may be substantially centered, e.g., spectrally, within the spectral bandwidth of the optical signal, or may be off-center within the spectral bandwidth of the optical signal, e.g., for optical signals having asymmetric spectral shapes. The signal bandwidth of an optical signal may refer to the width of the band of frequencies in which the optical signal operates, while the encoding of an optical signal may refer to the method used to represent the data being transported by the optical signal within the signal's bandwidth. In one example, wavelength multiplexed data stream 15 may include optical signals 10, 12, and 14.

Optical signal 10 may be a photon emitted from a quantum register and may include two polarizations states, 10a and 10b. Optical signal 10 may be polarization encoded, in which information is encoded using different polarization states, e.g., polarization states 10a and 10b of the photon. As illustrated by FIG. 1, polarization state 10a may represent a vertical polarization state of the photon while polarization state 10b may represent a horizontal polarization state of the photon, or polarization state 10a may represent a right-handed polarization state of the photon while polarization state 10b may represent a left-handed polarization state of the photon, or polarization states 10a, 10b may represent any suitable polarization states that are different from each other. Optical signal 12 may be a frequency encoded photonic qubit, in which information may have been encoded by associating each quantum state of the qubit with a specific frequency. As illustrated by FIG. 1, frequency 12a and frequency 12b may each represent a quantum state of the qubit associated with a specific frequency, and the bandwidth of optical signal 12 may include both frequencies 12a and 12b. Optical signal 14 may be a broadband time bin-encoded photon, in which information may have been encoded into specific time intervals within the optical signal's bandwidth. Optical signal 14 may encompass a broader range of frequencies relative to the other optical signals included in wavelength multiplexed data stream 15. Wavelength multiplexed data stream 15 may be received by an input port of WSS 18. WSS 18 may include one or more spectral filters, which may be arranged in a cascade.

WSS 18 may be a low-loss switch configured to support photonic degrees of freedom (e.g., polarization, time bin, frequency bin, or the like), as well as a wide range of quantum signals, such as bandwidths from below 1 GHz to bandwidths of 100 GHz or more. In the example shown, WSS 18 includes a 1×4 port configuration, i.e., one input port out to four output ports or vice versa, and a programmable filter system configuration. WSS 18 may be configured to allow endpoints 20A-20D to access any of a plurality of signal (e.g., channel) bandwidths, e.g., 1 GHz, 20 GHz, 400 GHz, or any suitable signal bandwidth. In some examples, WSS 18 may utilize silicon-on-insulator (SOI) techniques and/or photonic hardware, e.g., fabricated via a foundry.

WSS 18 may include one or more spectral filters and each spectral filter may be configured to switch an optical signal of the plurality of optical signals included in wavelength multiplexed data stream 15 to an output port of WSS 18 based on the center wavelength of the optical signal.

The spectral filters may each be configurable to adjust the signal bandwidth of the optical signal and may comprise a set of cascaded spectral filters. Each spectral filter of WSS 18 may include a resonator, such as a microresonator, a microring resonator, or the like. The PIC may further include one or more phase shifters configured to adjust and/or change the bandwidth (referred to herein as a filter bandwidth) of each spectral filter, e.g., via changing an optical path length of the resonator of each spectral filter. For example, the phase shifter may comprise a heater. In some examples, the heater may be as a power resistor configured to convert electrical current to heat. In some examples, the heater may comprise a thin metal trace, a doped semiconductor or portion of semiconductor, or any other suitable component configured to heat a portion of the resonator, and which may be positioned so as to control a temperature of at least a portion of the resonator, e.g., via heating. In one example, controlling the temperature may consist of the heater applying heat to (i.e., increasing the temperature) or not applying heat to (i.e., not increasing the temperature) at least a portion of the resonator. For example, the heater may be configured to control the temperature of the resonator in order to change the optical path length and filter bandwidth of the resonator by heating at least a portion of the resonator and/or by not providing heat to allow the resonator to cool (e.g., when heat is not applied to a portion of the resonator, the resonator may cool and the temperature of the resonator may decrease) via thermal conduction to other portions of the PIC, or any thermal mass to which the resonator may be thermally coupled. The resonator may be configurable to be heated or cooled (e.g., via thermal conduction) to adjust the filter bandwidth of the resonator, e.g., via an index of refraction configured to change upon experiencing a temperature change, thereby changing the optical path length of the resonator. In one example, the filter bandwidth of the resonator may refer to the range of frequencies that the resonator does not filter out. By adjusting the filter bandwidth of the resonator the signal bandwidth of the optical signal may be adjusted.

In other examples, resonators of WSS 18 may be configurable to adjust the filter bandwidth to by changing the optical path length of the resonator via other mechanisms or techniques, such as free-carrier plasma dispersion effect, a pockels effect, changing a physical dimension of the resonator, or any other suitable method, or combinations thereof, for changing the optical path length of the resonator.

WSS 18 may be configured to direct at least one of optical signals 10, 12, or 14 to at least one of endpoints 20. In the example shown, optical signals 10, 12, and 14 included in wavelength multiplexed data stream 15 may be distributed across four nodes by one or more spectral filter of WSS 18. For example, optical signal 10 is switched to endpoints 20C, optical signal 12 is switched to endpoint 20A, optical signal 14 is switched to endpoint 20D, and no optical signal is switched to endpoint 20B.

In the example shown, optical signal 10 includes a first polarization 10a and a second polarization 10b. WSS 18 may be configured to switch both the first polarization 10a and the second polarization 10b of optical signal 10 to an output port for output to endpoint 20C based on the center wavelength of optical signal 10. For example, WSS 18 may include a first spectral filter configured to switch the first polarization 10a and a second spectral filter configured to switch the second polarization 10b to an output port for output to endpoint 20C based on the center wavelength of optical signal 10.

In some examples, WSS 18 may have an insertion loss less than or equal to 2.5 decibels (dB). In some examples, the inclusion of both polarizations may increase the switched optical signal such that insertion loss requirements may be relaxed, e.g., to insertion losses of less than or equal to about 3.5 dB. In some examples, endfire coupling to photonic wire bonds of WSS 18 within a PIC may ensure facet coupling losses of about 1.6 dB (0.8 dB/facet). On-chip routing losses may be reduced by making use of wide (e.g., 2 μm-wide) waveguides in 220 nm SOI with specialty tapers used to ensure that conversion to higher-order modes is negligible between transitions to narrower waveguides. All on-chip spectral filters may be significantly over-coupled, thereby ensuring negligible drop loss.

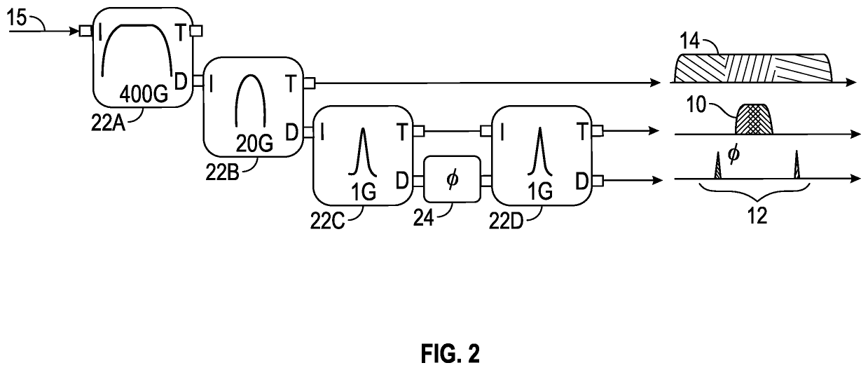

FIG. 2 is a conceptual diagram illustrating an example cascaded filter system, in accordance with one or more techniques of this disclosure. The system includes wavelength multiplexed data stream 15, spectral filters 22A, 22B, 22C, and 22D (collectively referred to as, “spectral filters 22”), and optical signals 10, 12, and 14.

In one example, WSS 18 may be designed for optimal performance over the full C-band (ITU grid), from 1530 nm to 1565 nm. The cascaded filter system illustrated in FIG. 2 may comprise of spectral filters and may be included in WSS 18 to isolate spectral slices over the C-band. In some examples, spectral filtering is performed exclusively using microresonators.

In some examples, WSS 18 may include resonators configured to approximate a box-like spectral response by using coupled microresonator-based filters (higher-order filters), e.g., as opposed to a Lorentzian line shape with a slow roll-off of the spectral response. For example, WSS may include adjacent second-order filters separated by twice their 3 dB bandwidth, and which may provide a wavelength reassignment fidelity of greater than or equal to 0.9999.

Each of the spectral filters (e.g., resonators) of WSS 18 may include an input port I, a through port T, and a drop port D. The input port I is configured to receive an optical signal data stream, which may be wavelength multiplexed data stream 15 or a portion of wavelength multiplexed data stream 15 (e.g., as the data stream progresses along the cascade), the through port T is configured to output a portion of the input optical signal data stream that is unaffected by the filter, e.g., to “pick-off” a portion of the incoming wavelength multiplexed data stream 15 or portion of wavelength multiplexed data stream 15 for sending unaffected downstream in the cascade, for example, to skip a subsequent filter, route to a subsequent filter, or to output to another component, and the drop port D is configured to output the filtered portion of the input optical signal data stream. In the example shown, the output of the through port T of filter 22B is optical signal 14, the output of the through ports T of filters 22C and 22D is optical signal 10, and the output of the drop port D of filter 22D is optical signal 12. In some examples, filter 22A may have a 400 GHz bandwidth, filter 22B may have a 20 GHz bandwidth, and filters 22C and 22D may have a 1 GHz bandwidth. Located between filters 22C and 22D may be a shifter 24 that may be used to prepare frequency bin encoded photons. Optical signals 10, 12, and 14 represent the filtered outputs of WSS 18 for an input wavelength multiplexed data stream 15.

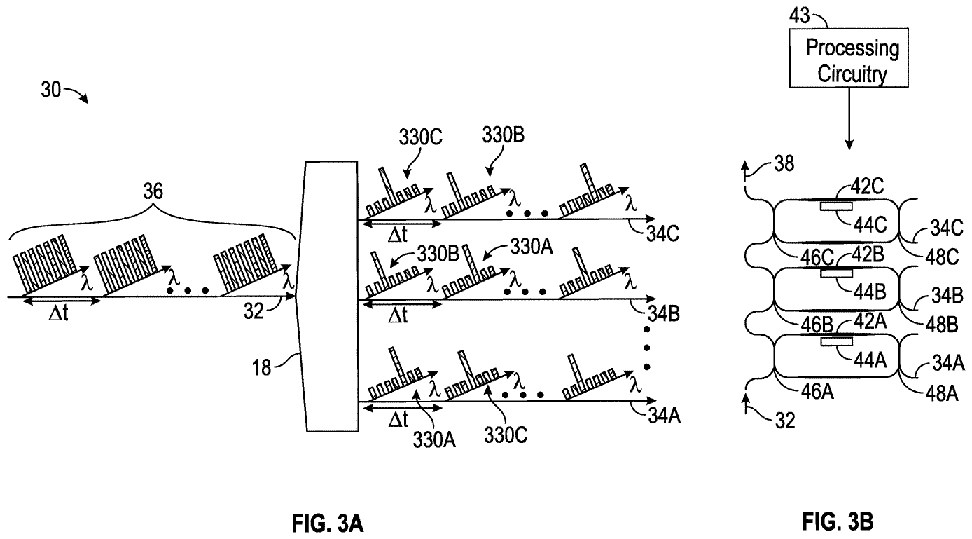

FIG. 3A is a conceptual diagram illustrating an example network 30 that includes WSS 18 implemented in a PIC, in accordance with one or more techniques of this disclosure. WSS 18 may be configured with an input port 32 and three output ports 34A, 34B, and 34C. WSS 18, via input port 32, may over time receive a series of wavelength multiplexed data streams 36. Wavelength multiplexed data streams 36 may be identical or different data streams and may each include a plurality of optical signals each assigned a wavelength and transmitted concurrently. In the example shown, the locations of each optical signal for each wavelength multiplexed data stream of wavelength multiplexed data streams 36 are separated for illustrative purposes to show an example of the spectral content of the optical signals, however, the optical signals may by spatially overlapping. WSS 30 may implement reconfigurable wavelength-selective routing of the optical signals to the three output ports 34A, 34B, and 34C.

In the example shown, input port 32 may, at a first time, receive a first wavelength multiplexed data stream 36 comprising at least first optical signal 330A, second optical signal 330B, and third optical signal 330C, and WSS 18 may switch first optical signal 330A to output port 34A, second optical signal 330B to output port 34B, and third optical signal 330C to output port 34C. Input port 32 may, at a second time (e.g., a time Δt later than the first time), receive a second wavelength multiplexed data stream 36 (e.g., that may be identical to, or different from, the first wavelength multiplexed data stream 36) and WSS 18 may switch the first optical signal 330A to output port 34B, the second optical signal 330B to output port 34C, and the third optical signal 330C to output port 34A.

FIG. 3B is a conceptual diagram of an example layout of WSS 18 of FIG. 3A. In the example shown, each of output ports 34A, 34B, and 34C are realized through racetrack resonators 42A-42C (collectively referred to as, “resonators 42”). Input port 32 may receive wavelength multiplexed data streams 36 where each optical signal may be routed either to one of output ports 34A, 34B, or 34C via the racetrack resonators 42, or to the through port 38. Racetrack resonators 42 may include multimode waveguides, and optical signals may be coupled into and out of racetrack resonators 42 via input couplers 46A-46C and output couplers 48A-48C. Racetrack resonators 42 may each include tapers comprising changes in the width or shape of a waveguide that are configured to improve coupling of optical signals into and out of each of racetrack resonators 42.

WSS 18 may comprise one or more phase shifters 44A-44C (collectively referred to as, “phase shifters 44”) configured to adjust and/or change the optical path length of resonators 42 to adjust the filter bandwidth of each of resonators 42 to adjust the signal bandwidth of the optical signal received by input port 32. For example, each of phase shifters 44 may comprise a heater configured to control the temperature (e.g., heat and/or allow to cool) of at least a portion of each of resonators 42, and each of resonators 42 may be configurable to be heated to adjust the filter bandwidth of resonator 42, e.g., resonators 42 may comprise an index of refraction configured to change upon experiencing a temperature change, thereby changing the optical path length of the resonator. In some examples, controlling the temperature of a portion of resonators 42 may change the optical path length by changing the physical length or dimensions of the resonator, e.g., making it longer or shorter.

Input port 32 may receive wavelength multiplexed data stream 36. Resonators 42 may route (i.e., switch) optical signals based on the center wavelength of the optical signals. In one example, resonator 42A may be a first spectral filter and may switch a first optical signal 330A with a first center wavelength to a first output port 34A. For example, resonator 42A may have a resonance such that optical signal 330A may couple to resonator 42A and may be output to port 34A, and optical signals 330B and 330C do not couple to resonator 42A and propagate towards resonators 42B and 42C and through port 38. Resonator 42B may be a second spectral filter and may switch a second optical signal 330B with a second center wavelength to a second output port 34B. For example, resonator 42B may have a resonance such that optical signal 330B may couple to resonator 42B and may be output to port 34B, and optical signal 330C propagates towards resonator 42C and through port 38. Similarly, resonator 42C may be a second spectral filter and may switch a second optical signal 330C with a third center wavelength to a third output port 34C. For example, resonator 42C may have a resonance such that optical signal 330C may couple to resonator 42C and may be output to port 34C, and any other optical signals that do not couple to any of resonators 42A, 42B, or 42C then propagate towards through port 38.

In one example, resonators 42A, 42B, and 42C may be configurable to be heated to adjust their filter bandwidths, and/or to adjust a signal bandwidth of optical signal 330A, 330B, or 330C. For example, heaters 44A-44C may control the temperature of resonators 42A-42C such that resonator 42A is resonant with optical signal 330C and couples optical signal 330C to output port 34A without coupling optical signals 33A and 330B, resonator 42B is resonant with optical signal 330A and couples optical signal 330A to output port 34B without coupling optical signal 330C, and resonator 42C is resonant with optical signal 330C and couple optical signal 330C to output port 34C. In some examples, the optical path length of each of resonators 42 is configurable to change when heated, e.g., by the same amount or by a different amount.

In some examples, input port 32 may receive a wavelength multiplexed data stream 36 comprising a first polarization and a second polarization different from the first polarization, e.g., for each of the optical signals within wavelength multiplexed data stream 36. Resonators 42 may be configured to switch both the first polarization and the second polarization of an optical signal to one of output ports 34A-34C based on the center wavelength of the optical signal, e.g., such that WSS 18 is able to use the signal within both polarization states. For example, some conventional wavelength selective switches may also be polarization dependent and unable to switch optical signals having a different polarization, and for optical signals having multiple polarization states, the non-switched polarizations may essentially be thrown away and not used, reducing a signal-to-noise of the optical signal. Resonators 42, however, may employ a polarization diversity scheme such that resonators 42 are configured to switch optical signals having a plurality of polarization states, the switching being based on wavelength, and resonators 42 do not throw away a portion of the signal because it has a different polarization.

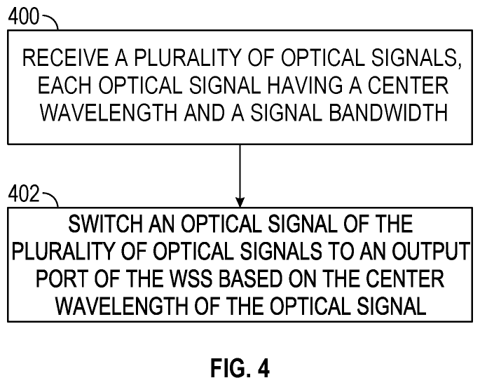

FIG. 4 is a flowchart of an example method of switching an optical signal by a WSS of a PIC, in accordance with one or more techniques of this disclosure. Although the example method of FIG. 4 is described with respect to WSS 18 and networks 2 and 30 of FIGS. 1-3B, the example method of FIG. 4 may be performed using any device including a WSS implemented within a PIC.

WSS 18 receives, at an input port of WSS 18 of a photonic integrated circuit, a plurality of optical signals each having a center wavelength that is different from the center wavelengths of the other optical signals, and a signal bandwidth (400). For example, WSS 18 may receive multiplexed data stream 36 at input port 32.

WSS 18 may comprise one or more spectral filters and may switch, by a spectral filter, an optical signal of the plurality of optical signals to an output port of WSS 18 based on the center wavelength of the optical signal (402). For example, WSS 18 may comprise resonators 42, and input port 32 may receive a multiplexed data stream 36 from which resonators 42 may switch a first optical signal 330A to output port 34A, e.g., by resonator 42A coupling first optical signal 330A to output port 34A.

Processing circuitry 43 may configure a spectral filter of WSS 18 with a filter bandwidth. In some examples, phase shifters 44 may configure the filter bandwidth by configuring, adjusting, and/or change the filter bandwidth of each of resonators 42, e.g., by adjusting an optical path length (e.g., either the index of refraction, the physical length, or both) of resonators 42. In some examples, processing circuitry 43 may control the one or more phase shifters 44 and may determine the wavelength and bandwidth of the optical signal routed to one or more outputs e.g., to endpoints 20 (FIG. 1). For example, processing circuitry 43 may be configured to cause phase shifters 44 to change the optical path length of one or more of resonators 44 by controlling the temperature of at least a portion of one or more of resonators 44. In some examples, WSS 18 may switch, via resonators 44, both a first polarization and a second polarization of the optical signals 300A-300C to output ports 34A-34C based on the center wavelength of the optical signals 300A-300C.

Processing circuitry 43 may be packaged with the photonic integrated circuit that includes WSS 18. A portion of processing circuitry 43 may in some cases be implemented in the photonic integrated circuit. Processing circuitry 43 may receive, via a communication link, configuration information for configuring the spectral filter of WSS 18.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

The disclosure may also be described in terms of the following clauses.

Example 1: A photonic integrated circuit comprising a wavelength selective switch (WSS), the WSS comprising: an input port configured to receive a plurality of optical signals, each optical signal having a center wavelength and a signal bandwidth, wherein the center wavelength of each optical signal is different from the center wavelengths of the other optical signals; an output port; and a spectral filter configured to switch an optical signal of the plurality of optical signals to the output port based on the center wavelength of the optical signal.

Example 2: The photonic integrated circuit of example 1, wherein the spectral filter is configurable to adjust the signal bandwidth of the optical signal.

Example 3: The photonic integrated circuit of example 1 or example 2, wherein the spectral filter comprises a resonator.

Example 4: The photonic integrated circuit of example 3, further comprising: a phase shifter configurable to change an optical path length of the resonator to adjust a filter bandwidth of the resonator to adjust the signal bandwidth of the optical signal.

Example 5: The photonic integrated circuit of example 4, wherein the phase shifter comprises a heater configured to control a temperature of at least a portion of the resonator to change the optical path length of the resonator.

Example 6: The photonic integrated circuit of any one of examples 1-5, wherein the optical signal is a first optical signal, wherein the center wavelength is a first center wavelength, wherein the spectral filter is a first spectral filter, wherein the output port is a first output port, and wherein the WSS further comprises: a second output port; and a second spectral filter configured to switch a second optical signal of the plurality of optical signals to the second output port based on a second center wavelength of the second optical signal.

Example 7: The photonic integrated circuit of claim 6, wherein the first spectral filter is configurable to adjust a first signal bandwidth of the first optical signal, and wherein the second spectral filter is configurable to adjust a second signal bandwidth of the second optical signal.

Example 8: The photonic integrated circuit of example 6 or example 7, wherein the first spectral filter comprises a first resonator, and wherein the second spectral filter comprises a second resonator.

Example 9: The photonic integrated circuit of example 8, wherein at least a portion of the first resonator is configurable to be heated to adjust a first filter bandwidth of the first resonator to adjust a first signal bandwidth of the first optical signal, and wherein at least a portion of the second resonator is configurable to be heated to adjust a second filter bandwidth of the second resonator to adjust a second signal bandwidth of the second optical signal.

Example 10: The photonic integrated circuit of example 9, wherein an optical path length of the first resonator is configurable to change when heated, and wherein an optical path length of the second resonator is configurable to change when heated.

Example 10: The photonic integrated circuit of any one of examples 1-9, wherein the optical signal comprises a first polarization and a second polarization different from the first polarization, and wherein the WSS is configured to switch both the first polarization and the second polarization of the optical signal to the output port based on the center wavelength of the optical signal.

Example 12: The photonic integrated circuit of example 11, wherein the spectral filter is a first spectral filter configured to switch the first polarization of the optical signal to the output port based on the center wavelength of the optical signal, the WSS further comprising: a second spectral filter configured to switch the second polarization of the optical signal to the output port based on the center wavelength of the optical signal.

Example 13: A method comprising: receiving, by an input port of a wavelength selective switch (WSS) of a photonic integrated circuit, a plurality of optical signals, each optical signal having a center wavelength and a signal bandwidth, wherein the center wavelength of each optical signal is different from the center wavelengths of the other optical signals; and switching, by a spectral filter, an optical signal of the plurality of optical signals to an output port of the WSS based on the center wavelength of the optical signal, wherein the WSS comprises the spectral filter.

Example 14: The method of example 13, further comprising: adjusting, by the spectral filter, the signal bandwidth of the optical signal.

Example 15: The method of example 14, wherein the spectral filter comprises a resonator.

Example 16: The method of example 15, wherein adjusting the signal bandwidth of the optical signal comprises: adjusting, by a phase shifter, an optical path length of the resonator to adjust a filter bandwidth of the resonator.

Example 17: The method of example 16, wherein the phase shifter comprises a heater configured to control a temperature of at least a portion of the resonator to change the optical path length of the resonator, wherein adjusting the optical path length of the resonator comprises: controlling the temperature, via the heater, of the at least a portion of the resonator.

Example 18: The method of any one of examples 13-17, wherein the optical signal comprises a first polarization and a second polarization different from the first polarization, the method further comprising: switching, by the spectral filter, both the first polarization and the second polarization of the optical signal to the output port based on the center wavelength of the optical signal.

Example 19: The method of example 18, wherein the spectral filter comprises a first polarization-specific spectral filter and a second polarization-specific spectral filter, the method further comprising: switching, by the first polarization-specific spectral filter, the first polarization of the optical signal to the output port based on the center wavelength of the optical signal; and switching, by the second polarization-specific spectral filter, the second polarization of the optical signal to the output port based on the center wavelength of the optical signal.

Example 20: A system comprising: a photonic integrated circuit comprising a wavelength selective switch (WSS); and processing circuitry configured to: configure a spectral filter of the WSS with a filter bandwidth.

Example 21: The system of example 20, wherein the spectral filter comprises a resonator, and wherein the processing circuitry is configured to: cause a phase shifter to adjust the filter bandwidth of the resonator via changing an optical path length of the resonator.

1. A photonic integrated circuit comprising a wavelength selective switch (WSS), the WSS comprising:
an input port configured to receive a plurality of optical signals, each optical signal having a center wavelength and a signal bandwidth, wherein the center wavelength of each optical signal is different from the center wavelengths of the other optical signals;
an output port; and
a spectral filter configured to switch an optical signal of the plurality of optical signals to the output port based on the center wavelength of the optical signal.

2. The photonic integrated circuit of claim 1, wherein the spectral filter is configurable to adjust the signal bandwidth of the optical signal.

3. The photonic integrated circuit of claim 1, wherein the spectral filter comprises a resonator.

4. The photonic integrated circuit of claim 3, further comprising:
a phase shifter configurable to change an optical path length of the resonator to adjust a filter bandwidth of the resonator to adjust the signal bandwidth of the optical signal.

5. The photonic integrated circuit of claim 4, wherein the phase shifter comprises a heater configured to control a temperature of at least a portion of the resonator to change the optical path length of the resonator.

6. The photonic integrated circuit of claim 1, wherein the optical signal is a first optical signal, wherein the center wavelength is a first center wavelength, wherein the spectral filter is a first spectral filter, wherein the output port is a first output port, and wherein the WSS further comprises:
a second output port; and
a second spectral filter configured to switch a second optical signal of the plurality of optical signals to the second output port based on a second center wavelength of the second optical signal.

7. The photonic integrated circuit of claim 6,
wherein the first spectral filter is configurable to adjust a first signal bandwidth of the first optical signal, and
wherein the second spectral filter is configurable to adjust a second signal bandwidth of the second optical signal.

8. (canceled)

9. The photonic integrated circuit of claim 6, wherein:
the first spectral filter comprises a first resonator,
the second spectral filter comprises a second resonator,
at least a portion of the first resonator is configurable to be heated to adjust a first filter bandwidth of the first resonator to adjust a first signal bandwidth of the first optical signal, and
at least a portion of the second resonator is configurable to be heated to adjust a second filter bandwidth of the second resonator to adjust a second signal bandwidth of the second optical signal.

10. The photonic integrated circuit of claim 9, wherein an optical path length of the first resonator is configurable to change when heated, and wherein an optical path length of the second resonator is configurable to change when heated.

11. The photonic integrated circuit of claim 1, wherein the optical signal comprises a first polarization and a second polarization different from the first polarization, and wherein the WSS is configured to switch both the first polarization and the second polarization of the optical signal to the output port based on the center wavelength of the optical signal.

12. The photonic integrated circuit of claim 11, wherein the spectral filter is a first spectral filter configured to switch the first polarization of the optical signal to the output port based on the center wavelength of the optical signal, the WSS further comprising:
a second spectral filter configured to switch the second polarization of the optical signal to the output port based on the center wavelength of the optical signal.

13. A method comprising:
receiving, by an input port of a wavelength selective switch (WSS) of a photonic integrated circuit, a plurality of optical signals, each optical signal having a center wavelength and a signal bandwidth, wherein the center wavelength of each optical signal is different from the center wavelengths of the other optical signals; and
switching, by a spectral filter, an optical signal of the plurality of optical signals to an output port of the WSS based on the center wavelength of the optical signal, wherein the WSS comprises the spectral filter.

14. The method of claim 13, further comprising:
adjusting, by the spectral filter, the signal bandwidth of the optical signal.

15. The method of claim 14, wherein the spectral filter comprises a resonator.

16. The method of claim 15, wherein adjusting the signal bandwidth of the optical signal comprises:
adjusting, by a phase shifter, an optical path length of the resonator to adjust a filter bandwidth of the resonator.

17. The method of claim 16, wherein the phase shifter comprises a heater configured to control a temperature of at least a portion of the resonator to change the optical path length of the resonator, wherein adjusting the optical path length of the resonator comprises:
controlling the temperature, via the heater, of the at least a portion of the resonator.

18. The method of claim 13, wherein the optical signal comprises a first polarization and a second polarization different from the first polarization, the method further comprising:
switching, by the spectral filter, both the first polarization and the second polarization of the optical signal to the output port based on the center wavelength of the optical signal.

19. The method of claim 18, wherein the spectral filter comprises a first polarization-specific spectral filter and a second polarization-specific spectral filter, the method further comprising:
switching, by the first polarization-specific spectral filter, the first polarization of the optical signal to the output port based on the center wavelength of the optical signal; and
switching, by the second polarization-specific spectral filter, the second polarization of the optical signal to the output port based on the center wavelength of the optical signal.

20. A system comprising:
a photonic integrated circuit comprising a wavelength selective switch (WSS); and
processing circuitry configured to:
configure a spectral filter of the WSS with a filter bandwidth.

21. The system of claim 20, wherein the spectral filter comprises a resonator, and wherein the processing circuitry is configured to:
cause a phase shifter to adjust the filter bandwidth of the resonator via changing an optical path length of the resonator.
